(19) United States
(12) Patent Application Publication
(10) Pub. No.: US 2010/0186426 A1
(43) Pub. Date: Jul. 29, 2010

(54) METHOD FOR TRANSPORTING LIQUIFIED NATURAL GAS

(76) Inventor: Steven Campbell, St. John's (CA)

Correspondence Address: BLAKE, CASSELS & GRAYDON, LLP, 45 O'CONNOR ST., 20TH FLOOR, OTTAWA, ON, K1P 1A4, CA

(21) Appl. No.: 12/563,813

(22) Filed: Sep. 21, 2009

Related U.S. Application Data
(63) Continuation-in-part of application No. 11/454,882, filed on Jun. 19, 2006, now abandoned.
(60) Provisional application No. 60/691,782, filed on Jun. 20, 2005.

(51) Int. Cl. F17C 3/00; F17C 9/02; F17C 13/00

(52) U.S. Cl. 62/50.2; 62/45.1; 62/50.7

(57) ABSTRACT

A method of transporting natural gas by cooling and pressurizing retained natural gas to liquefy the retained natural gas within a fiber reinforced plastic pressure vessel.

### CROSS-REFERENCE TO RELATED APPLICATIONS

This application is a continuation-in-part of U.S. patent application Ser. No. 11/454,882 filed on Jun. 19, 2006 which claims benefit from U.S. Provisional Application No. 60/691,782, filed Jun. 20, 2005.

### FIELD OF THE INVENTION

The present invention relates to a method of transporting natural gas and more particularly, the present invention relates to a method and system for transporting pressurized and liquefied natural gas.

### BACKGROUND OF THE INVENTION

Low emissions and the high cost of oil have made natural gas the global fossil fuel of choice. Currently, there are 6000 trillion cubic feet (TCF) of proven natural gas reserves in the world. Approximately half of those reserves are considered stranded; when it is not economical to transport by pipeline or ship-based liquefied natural gas (LNG). Both pipelines and LNG have economical limits; pipelines in distance, LNG by project and reserve size minimums.

Pipelines transport natural gas as a vapor, whereas LNG is transported as a liquid. To liquefy natural gas at ambient pressure requires cryogenic refrigeration to −165 degree. C. This is a costly and relatively complex process; however, due to the increased value of natural gas, the global demand for LNG has skyrocketed. Although this is the case, approximately 3000 TCF of proven reserves remain stranded.

To economically transport stranded and other natural gas reserves, various methods of Compressed Natural Gas (CNG) transportation methods have been proposed and are in various stages of development. The most technically feasible and cost effective method of CNG transportation is through the use of large Type 4 fiber reinforced plastic (FRP) pressure vessels. Unlike steel-based pressure vessels, FRP pressure vessels or bottles are lightweight, corrosion resistant, and have safe failure modes if punctured. The composite structure of FRP pressure vessels are resistant to temperatures as low as −80 degree C. or even lower; however, the port boss in the domes of Type 4 FRP pressure bottles, used for connecting to manifold piping systems, are made of metal, and therefore, limited by the metallurgy used. Carbon steels loose strength and become brittle below temperatures near −40 degree C. Duplex, super duplex, precipitation hardened and titanium alloys in contrast maintain strength and integrity in low temperatures; which therefore would allow the low-temperature range of a Type 4 FRP pressure vessel to be reached.

Lowering the temperature of natural gas while maintaining a constant pressure results in gas density increase. The concentrations of C1+ hydrocarbons determine the thermodynamic characteristics of a particular mixture under varied temperature and pressure combinations. Higher density allows for higher volumes of gas that can be stored in the same space, and therefore transported by ship, modal rail or roadway. Vapor pressure is somewhat proportionate to the proportions of larger carbon chain molecules in a gas mixture. A higher concentration of C2+ in a mixture lowers the vapor pressure and therefore the inverse pressure temperature combination that determines when a mixture begins to liquefy. The phase envelope for a particular natural gas mixture shows the relative vapor/liquid proportion at any given pressure and temperature combination. When fully liquefied, density within the phase envelope is maximized; however, a combination of gas and liquid may be more practical for storing and or handling.

It has been found that the use of Type 4 FRP pressure vessels to store natural gas at low temperatures to partially or completely liquefy the said gas is effective and has wide commercial application. The use of Type 4 FRP pressure vessels to store pressurized liquefied natural gas (PLNG) allows significantly large quantities of natural gas to be transported by ship, tractor trailer, and modal container, or stored on land. Compared to compressed natural gas (CNG) stored at ambient temperature, the density and therefore net amount of natural gas is significantly increasing.

Using Type 4 FRP pressure vessels to store PLNG is a safe, reliable, lightweight, corrosion resistant and cost effective way to transport natural gas from source to market. It is also economically effective to store natural gas on land for surge containment and storage.

Insulation of the FRP PLNG system will help keep the system cool and therefore stabilize the liquid from boiling at sub-zero temperatures.

In view of the limitations in the art, it would be highly desirable to have a method and a system for transporting greater quantities of natural gas.

The present invention satisfies this need.

### SUMMARY OF THE INVENTION

One object of the present invention is to provide an improved method and system for transporting higher quantities of natural gas by pressurization and conventional thermal reduction to obtain liquefication.

A further object of one embodiment of the present invention is to provide a method of transporting natural gas, comprising providing a source of natural gas, providing a Type 4 fiber reinforced pressure vessel for retaining the natural gas, and cooling and pressurizing retained natural gas to liquefy the retained gas within the Type 4 fiber reinforced plastic pressure vessel.

A further object of the present invention is to provide a system for transporting natural gas having fluid management apparatus and transport apparatus, the fluid management apparatus comprising a plurality of Type 4 fiber reinforced plastic pressure vessels for retaining the natural gas, fluid connection means interconnecting the pressure vessels, valve means in fluid communication with the fluid connection means for admitting and discharging the gas exteriorly of the vessels or between the vessels, support means for supporting the plurality of Type 4 fiber reinforced pressure vessels, the fluid transport apparatus, comprising a vehicle for receiving the fluid management apparatus, cooling means for cooling the natural gas, and pressurizing means for pressurizing the natural gas, whereby pressurized and liquefied natural gas is transportable with the vehicle.

Yet another object of one embodiment of the present invention is to provide a system for transporting natural gas having fluid management apparatus and transport apparatus, the fluid management apparatus comprising a plurality of Type 4 fiber reinforced plastic pressure vessels for retaining the natural gas, fluid connection means interconnecting the pressure vessels, valve means in fluid communication with the fluid connection means for admitting and discharging the gas exteriorly of the vessels or between the vessels, support means for supporting the plurality of fiber reinforced plastic pressure vessels, the fluid transport apparatus, comprising a vehicle for receiving said fluid management apparatus, cooling means for cooling the natural gas, and pressurizing means for pressurizing the natural gas, whereby pressurized and liquefied natural gas is transportable with the vehicle.

Having thus generally described the invention reference will now be made to the accompanying drawings illustrating preferred embodiments.

### BRIEF DESCRIPTION OF THE DRAWINGS

FIG. 1 is a graphical illustration of the phase envelopes for natural gas;

FIG. 2 is an enlarged view of the manifold system and Type 4 FRP vessels as connected according to one embodiment;

FIG. 3 is a top view of the ship hold with the Type 4 FRP pressure vessels held in position by a cassette modular framing system;

FIG. 4 is a side view of FIG. 3;

FIG. 5 is a perspective view of a cassette support framing system according to one embodiment of the present invention;

FIG. 6 is a view of the cassette with a Type 4 FRP pressure vessel in situ together with the manifold system;

FIG. 7 is a side view of a group of individual stacked cassettes with modules in position;

FIG. 8 is a view of another vehicle for retaining the Type 4 FRP vessels; and

FIG. 9 is a view of a land based system.

Similar numerals denote similar elements.

### DETAILED DESCRIPTION OF THE PREFERRED EMBODIMENTS

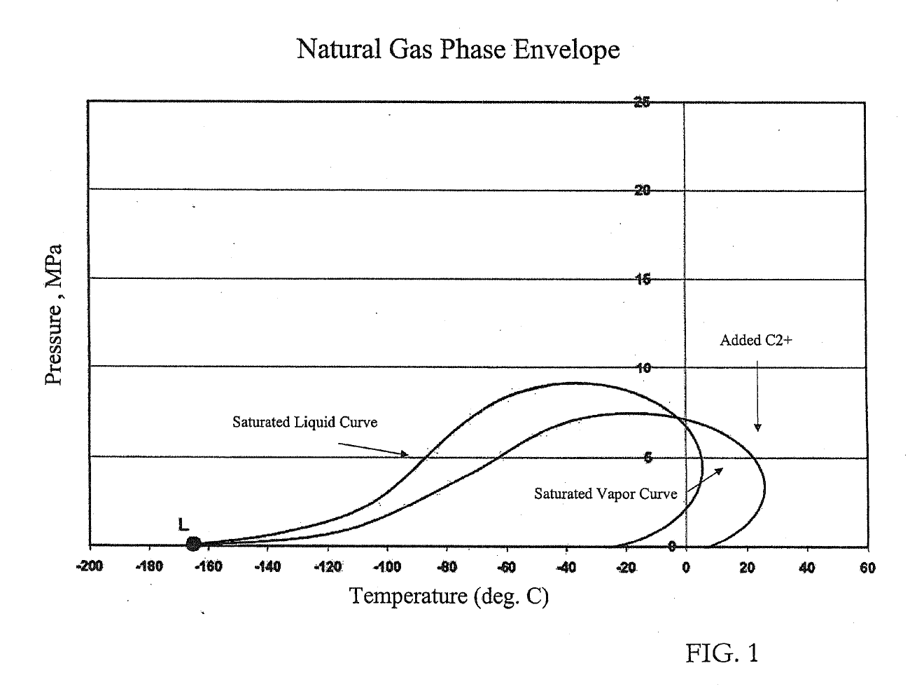

For modes of PLNG transportation and storage including a ship, the combination of low temperature and pressure to increase density near or to the point of liquefaction can be further optimized by increasing the C2+ concentration of the gas mixture. It is known that increased concentrations of C2+ in a gas mixture, lowers the vapor pressure of the entire mixture. Thus, higher concentrations of C2+ in the gas mixture will allow for larger net volumes of natural gas to be stored and transported comparatively. This is generally depicted in the phase diagram of FIG. 1.

Using a vertically oriented Type 4 FRP PLNG gas containment system, natural gas may be discharged from the containment system as a vapor or a liquid. Vapor may be discharged through the upper manifold piping system. Liquid natural gas may he discharged through the lower manifold system. To counteract Joule-Thompson effects during de-pressurization and maintain minimum/maximum temperatures in the system, some heat may have to be applied. In one possibility, the heat could be applied directly to one or more manifolds.

The thermodynamic characteristics of a natural gas/liquids mixture are determined by the concentrations of C2 and C3+ in the mixture. The higher the concentration of C2+, the lower the vapor pressure of the mixture. Therefore, by adding or maintaining a significant C2 and C3+ concentration, a relatively low vapor pressure may be obtained. A lower vapor pressure will allow for the gas being injected into a Type 4 FRP PLNG storage system to liquefy with less pressure or elevated temperature, than with a higher vapor pressure.

By making use of the thermodynamic characteristics, control of the boil rate during discharge permits significant proportions of C2 and C3+ hydrocarbons to remain as a liquid in the Type 4 FRP PLNG system. This obviates the requirement of having to remove C2 and C3+ hydrocarbons before injecting the gas into a pipeline distribution network. Most pipeline distribution systems have a restriction on the thermal content of gas entering into a pipeline system. In North America, the limit is generally 1050 Btu's (British thermal units) per scf (standard cubic feet) of gas.

As the pressure in the Type 4 FRP PLNG system is reduced at assumed constant temperature, the gas will start to boil. Controlling the rate of pressure drop and temperature change in the storage system will control the boil rate of liquid gas. When the boil rate is constricted, the tendency is for the lighter hydrocarbons to boil first. C2, but moreover. C3+ hydrocarbons tend to stay as a liquid. Thus, as the liquid/vapor interface lowers toward the bottom of the FRP bottles at a constrained rate, the concentration of C2 and C3+ molecules in liquid phase increases. The propensity is for the heaviest molecules to collect over repeated cycles as they are less likely to vaporize at a constrained rate of boil. The heavier hydrocarbon concentration change during discharge of the cargo will also change the vapor pressure of the liquid gas mixture. The greater the concentration of C2+ hydrocarbons, the lower the vapor pressure of the changing mixture.

By maintaining a low temperature in the Type 4 FRP PLNG containment system during discharge, a high concentration of C2 and C3+ will remain as a liquid at the bottom part of the system. This C2 and C3+ mixture can then be returned to the source of natural gas and reused for the next shipment without processing the gas externally of the containment storage system to remove C2 and C3+.

As the concentration of C2 and C3+ builds over time, some C2 and C3+ may even be used for power generation on board the ship. However, there will be an economical crossover point where additional C2 and C3+ hydrocarbons no longer increase the net amount of cargo transported on a PLNG carrier or modal system. Any C2 and C3+ over this amount would not be economically advantageous. The most cost effective system will be at the crossover point.

Alternatively, PLNG may be discharged through the lower manifold and re-gasified on deck for offloading. It may even be offloaded as a liquid if desired for direct injection into a land-based storage system. If this alternative is chosen, then some C2 and C3+ liquids used to achieve increased density could be extracted separately and restored for the return journey.

C2 and C3+ concentrations in a land based Type 4 FRP PLNG storage system would have the same or similar density/capacity increase effect within an equal space. The method described herein could also be useful in an intermodal container for road, rail and marine transport of PLNG.

This method of PLNG storage would also be cost effective to transport ethane (C2) as a commodity of its own. Ethane is the feedstock for the petrochemical industry. It therefore has a significant commodity value. Ethane is currently only transported by pipeline. The feedstock to the petrochemical industry is therefore limited to sources obtainable by pipeline. PLNG offers another transportation mode of much larger distances than feasible via pipeline transport.

To overcome thermal input to the system during compression and loading, the residual C2 and C3+ hydrocarbons can be chilled to the minimum temperature allowed at a specified pressure. During the return journey, the residual natural gas liquids and captured C4 and C5+ hydrocarbons, may be super-chilled without danger of rapid depressurization causing a temperature drop. The pressure drop would be negligible. Therefore, when mixed with new and possibly hot gas coming into the system, the temperature will equalize, as required to achieve the effect desired. If incoming gas into the system is through the lower manifolds, the incoming gas would have to percolate through the heavy and cold hydrocarbon residual. This would help to mix the heavy hydrocarbons stored in the bottoms of the systems to mix with the incoming gas.

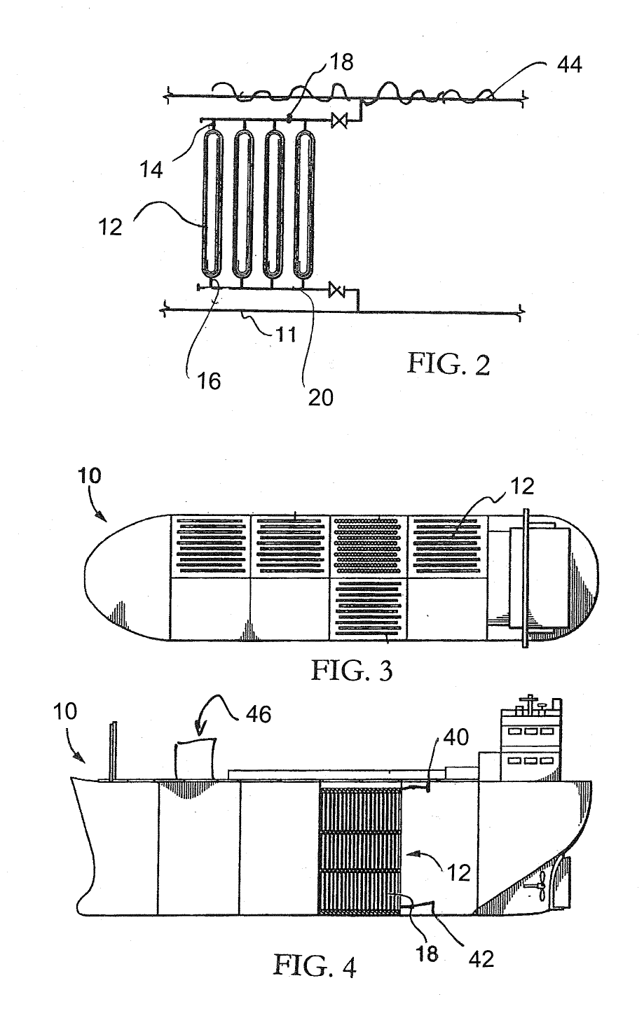

With reference to FIGS. 2 through 4 shown as a vehicle, shown in the example as a ship 10 with the Type 4 FRP pressure vessels generally denoted by numeral 12. The vessels each have an upper metal alloy port boss 14 and a lower metal port boss 16 which may be composed of the metals noted herein previously (duplex, super duplex, precipitation hardened) and other suitable stainless steels of similar grade. The individual port bosses are connected by upper and lower piping manifolds 18, 20, respectively. The piping manifolds 18 and 20 will be selected of similar materials as the port bosses and will have the feature of being capable of withstanding low or ultra low temperatures.

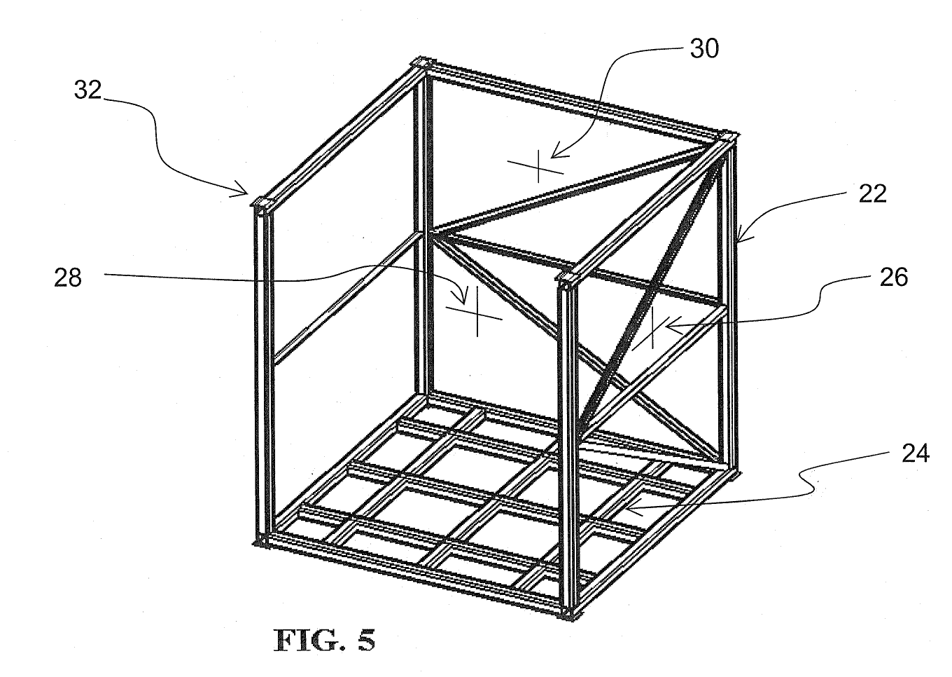

The Type 4 FRP vessels 12 may be held in modular cassette frames, denoted in FIG. 5 by numeral 22. The cassette frames 22 can be stacked and nested in the hold of a ship as is indicated in FIGS. 3 and 4. The frame is designed to isolate the vessels including the piping manifolds from ship movement and vibration. It is also useful to facilitate full visual inspection of the fiber reinforced plastic pressure vessels while in service. The cassette is composed of a frame with a bottom grid 24 which is for the purpose of supporting the vessels (the vessel is not shown in FIG. 4). The frame has three sides 26, 28 and 30 and an open top. The lack of a top section is to facilitate ease of installation for the vessels into frame 22 and also is useful from a mass point of view; the absence of a top and one or more sides reduces the overall mass.

Once installed in the hold of a ship as shown in FIG. 4 the adjacent cassette frames can be bolted together and include a bushing 32 (see FIG. 5) to absorb hydrodynamic movement during traveling. Where the cassettes 22 are stacked in a vertical manner, it will be evident that the bottom grid 24 of the upper cassette provides for lateral bracing of the lower cassette frame as is clear from FIG. 4.

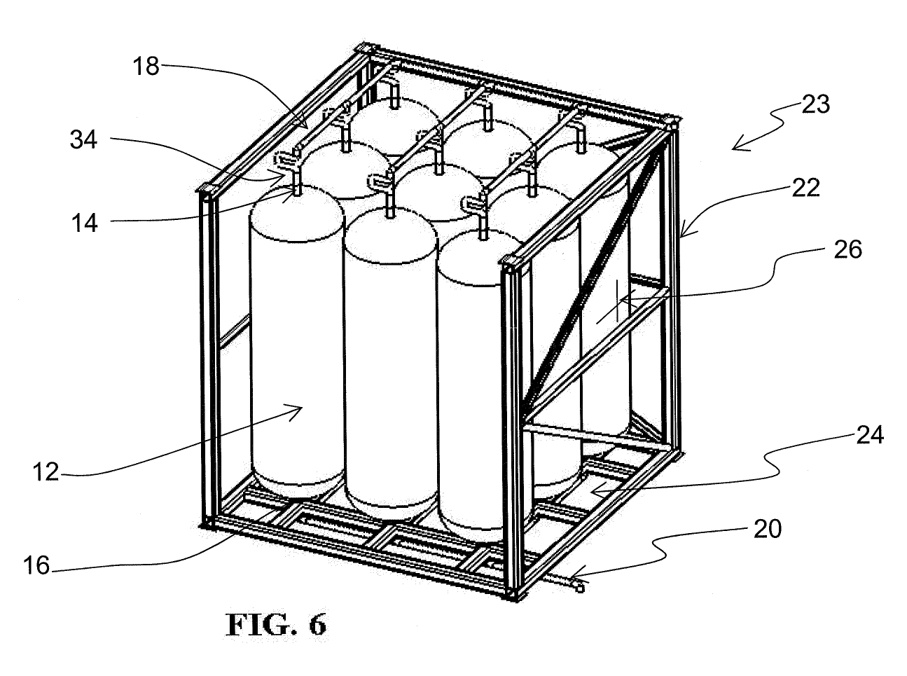

Each cassette frame 22 is equipped with upper and lower piping manifolds 18 and 20 respectively, to connect the top and bottom 14 and 16 port bosses of vertical vessels 12. The bottom manifold 20 is secured to the grid 24 of the cassette 22. The upper manifold 18 is also secured however, it is guided by guides 34 to allow for elongation of the pressure vessels during pressurization. This is illustrated in FIG. 6. The connection of the vessels 12 to pipe it through the piping manifolds 18 and 20 may be directly welded or via high pressure flange connections (not shown) which are integral with the port bosses 14, 16 of the vessels 12.

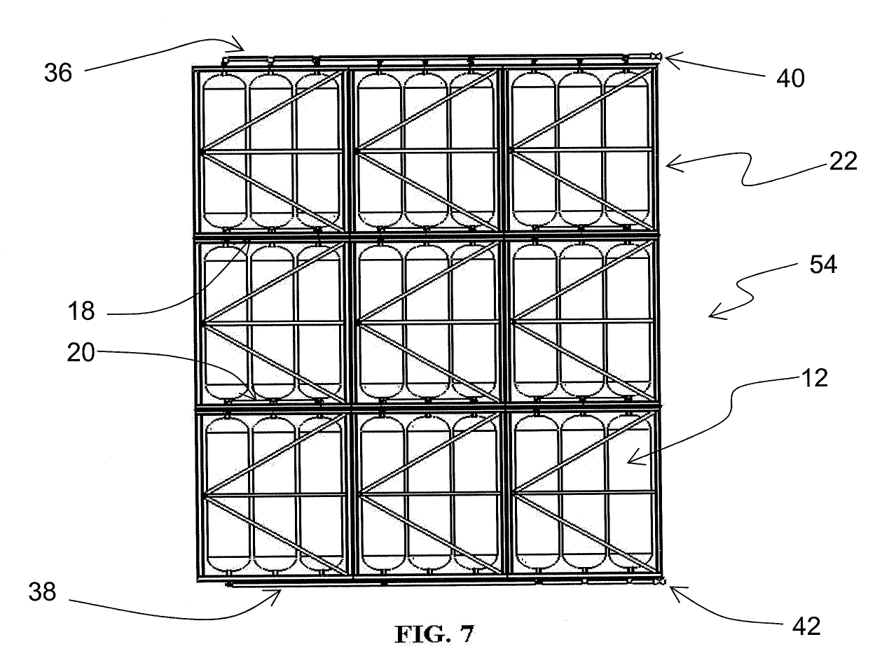

To create a stack or cluster of cassette modules 22, the upper manifold 18 of a lower cassette may be connected to the lower manifold 20 of the upper cassette. The lowermost and uppermost manifolds would then be connected to the respective piping that would lead to the first isolation valves located on the deck of the ship 10. The uppermost and lowermost manifolds denoted by numerals 36 and 38 in FIG. 7 would be connected to isolation valves located in the deck of ship 10, which valves are denoted by numerals 40 and 42, the latter illustrated in FIG. 4.

As an option, the manifold piping may be insulated with suitable insulation denoted by numeral 44 in FIG. 2 or the entire cassette system may be composed of insulated frames. As a further possibility, the inside of the ship's hold may be insulated.

On the main deck of the ship 10, there is included refrigeration and compression equipment, globally denoted by numeral 46 in FIG. 4.

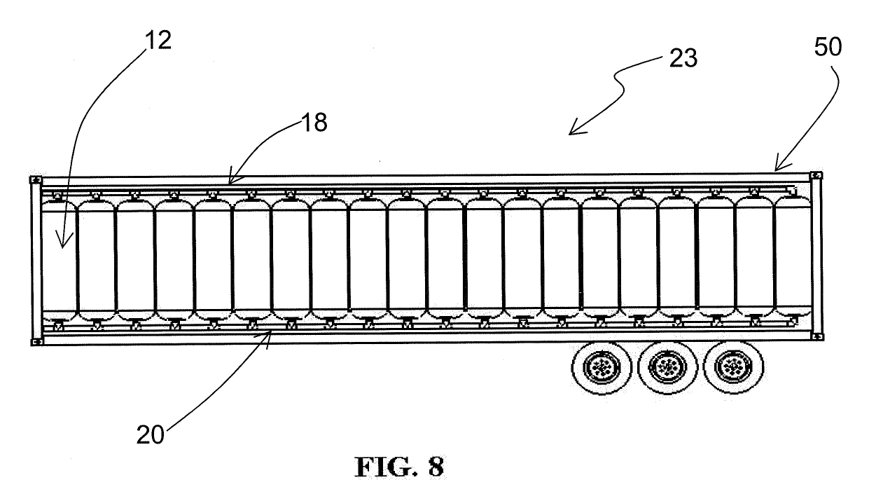

Turning to FIG. 8, shown is a further embodiment of the invention where the individual cassettes 22 have been installed on a trailer 50 or intermodal container. Suitable pressurization and compression equipment may be included on board the trailer (not shown) or simply extraneous of the trailer 50 or intermodal container.

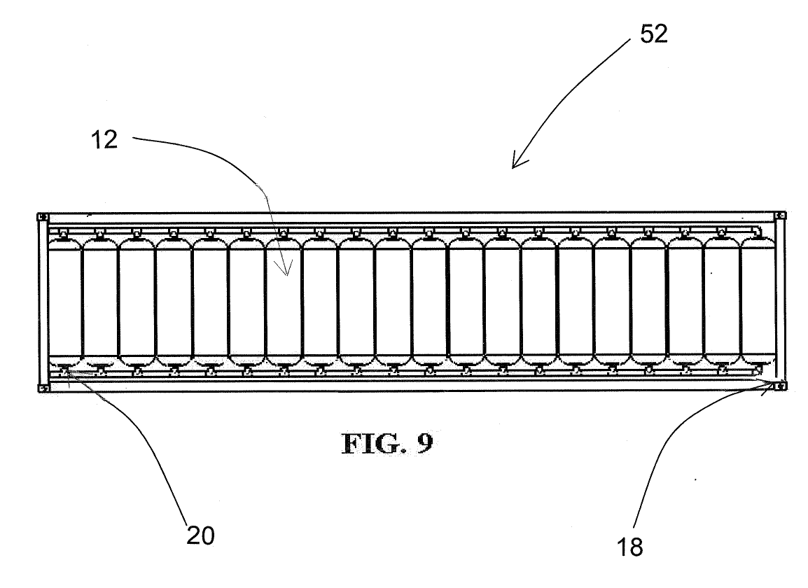

FIG. 9 schematically illustrates a land based system 52, where the same components are incorporated from FIG. 8 with exception that the trailer 50 (FIG. 8) is deleted and replaced by an intermodal frame.

Although embodiments of the invention have been described above, it is limited thereto and it will be apparent to those skilled in the art that numerous modifications form part of the present invention insofar as they do not depart from the spirit, nature and scope of the claimed and described invention.

1. A method of transporting pressurized and liquefied natural gas, comprising:
providing a source of natural gas;
providing a Type 4 fiber reinforced plastic pressure vessel for retaining said natural gas; and
cooling and pressurizing retained natural gas to liquefy said retained gas within said Type 4 fiber reinforced plastic pressure vessel.

2. The method as set forth in claim 1, further including adjusting the concentration of at least one of C2 and C3+ present in said natural gas during storage of said natural gas to decrease the vapor pressure thereof.

3. The method as set forth in claim 1, further including maintaining said C2 and said C3+ in a liquid state during storage and gas offloading for recycling to said source of natural gas.

4. The method as set forth in claim 1, further including maintaining said C2 and said C3+ in a liquid state in said source of said pressurized and liquefied natural gas during discharge of said Type 4 fiber reinforced plastic pressure vessel.

5. The method as set forth in claim 4, wherein said natural gas is discharged/de-pressurized in a controlled manner for controlling the boil rate of pressurized and liquefied natural gas to increase the concentration of C2 and C3+ remaining as liquid in said vessel during discharge/de-pressurization.

6. The method as set forth in claim 5, wherein said C2 and said C3+ remaining in said fiber reinforced pressure vessel subsequent to discharge of said natural gas is further cooled during return journey to the source of natural gas.

7. The method as set forth in claim 5, wherein chilled C2 and said C3 are retained in said vessel and mixed with natural gas during reloading of said natural gas into said Type 4 pressure vessel to lower the temperature of reloaded natural gas and the resulting mixture.

8. The method as set forth in claim 7, wherein retained and super-chilled C2 and said C3+ collectively lower the vapor pressure of the combined mixture of natural gas.

9. The method as set forth in claim 1, wherein in alternation, pressurized and liquefied natural gas is discharged from said vessel through a lower most manifold connected thereto.

10. Use of a Type 4 fiber reinforced plastic pressure vessel for retaining pressurized and liquefied natural gas.

11. The use as set forth in claim 10, wherein said vessel includes control valve means for admitting and discharging said gas, said means composed of a steel selected from duplex, super duplex and/or precipitation hardened stainless steel.

12. The use as set forth in claim 10, wherein said vessel is composed of a material selected from the group consisting of glass, carbon, and aramid filament fiber.

13. The use as set forth in claim 10, wherein said vessel has an operating temperature below at least −40 C.

14. The use of Type 4 FRP pressure vessels installed inside of refrigerated intermodal containers for intermodal transport of PLNG.

15. A system for transporting natural gas having fluid management apparatus and transport apparatus, said fluid management apparatus comprising:
a plurality of Type 4 fiber reinforced plastic pressure vessels for retaining said natural gas;
fluid connection means interconnecting said pressure vessels;
valve means in fluid communication with said fluid connection means for admitting and discharging said gas exteriorly of said vessels or between said vessels in a controlling manner;
support means for supporting said plurality of Type 4 fiber reinforced plastic pressure vessels;
cooling means for cooling said natural gas; and
pressurizing means for pressurizing said natural gas.

16. The system as set forth in claim 14, wherein said support means comprises a cassette frame.

17. The system as set forth in claim 14, wherein said fluid connection means comprises a manifold network interconnecting individual vessels.

18. The system as set forth in claim 14, wherein each said vessel includes at least one set of first and second opposed valves.

19. The system as set forth in claim 14, wherein said vehicle is selected from the group consisting of a marine vessel, automobile and train.

20. A system for land based storage of natural gas, comprising:
a plurality of fiber reinforced plastic pressure vessels for retaining said natural gas;
fluid connection means interconnecting said pressure vessels;
valve means in fluid communication with said fluid connection means for admitting, and discharging said gas exteriorly of said vessels or between said vessels;
support means for supporting said plurality of fiber reinforced plastic pressure vessels;
cooling means for cooling said natural gas; and
pressurizing means for pressurizing said natural gas.
